(19) United States
(12) Patent Application Publication
(10) Pub. No.: US 2024/0266774 A1
(43) Pub. Date: Aug. 8, 2024

(54) CONNECTOR

(71) Applicant: Yazaki Corporation, Minato-ku (JP)

(72) Inventors: Tooru KOBAYASHI, Makinohara-shi (JP); Yoshinori ISHIKAWA, Makinohara-shi (JP); Akane KIKUCHI, Tokyo (JP)

(73) Assignee: Yazaki Corporation, Minato-ku (JP)

(21) Appl. No.: 18/420,291

(22) Filed: Jan. 23, 2024

(30) Foreign Application Priority Data
Feb. 6, 2023 (JP) 2023-016062

(51) Int. Cl. H01R 13/424; H01R 13/516

(52) U.S. Cl. CPC H01R 13/424; H01R 13/516

(57) ABSTRACT

A connector 1 is to be mated with a mating connector, and includes an outer housing 2 and a cover 10 covering a surface of the outer housing 2 on an opposite side from the mating connector. The outer housing 2 includes a first terminal holding portion 2A for holding a first terminal-attached electric wire 72, 82 and a second terminal holding portion 2B for holding a second terminal-attached electric wire 21. The first terminal holding portion and the second terminal holding portion are arranged in a first direction Z. The cover includes an electric wire outlet port 14 through which electric wires 73, 83, 24, passed through the first terminal holding portion and the second terminal holding portion, extend out in the first direction. The second terminal holding portion is at a position closer to the electric wire outlet port than is the first terminal holding portion. An end portion 2Bb, on a side of the cover, of the second terminal holding portion is situated at a position farther from the cover than is an end portion 2Ab, on the side the cover, of the first terminal holding portion.

### TECHNICAL FIELD

The present invention relates to a connector.

### BACKGROUND

Conventionally, a lever-type connector has been proposed that includes a female connector, a male connector, and a lever for mating the female connector and the male connector (for example, see Patent Document 1).

A lever-type connector described in Patent Document 1 is configured such that, by rotating a lever while the lever pivotally supported on a female connector, the female connector and a male connector are brought close together and mated. A male connector (hereinafter referred to as a connector) includes an approximately rectangular hood portion that opens upwards, and an electric wire cover is fitted on the lower surface of the hood portion. This electric wire cover has an electric wire outlet port through which electric wires are passed, and the electric wires connected to the male connector pass through the electric wire outlet port in a direction perpendicular to the vertical direction.

### RELATED ART

### Patent Document

[Patent Document 1] JP 2006-196225 A

### SUMMARY OF THE INVENTION

### Problem to be Solved by the Invention

In such a conventional connector, the number of electric wires to be bundled increases at a position closer to the electric wire outlet port of the electric wire cover. For this reason, the electric wires may interfere with each other near the electric wire outlet port of the electric wire cover, making the task of routing the electric wires cumbersome.

It is an object of the present invention to provide a connector that improves the workability in routing electric wires.

### Solution to Problem

In order to solve the above problems and achieve the object, the invention set forth in claim 1 is a connector to be mated with a mating connector, and the connector includes an outer housing and a cover configured to cover a surface of the outer housing on an opposite side from the mating connector, wherein the outer housing includes a first terminal holding portion for holding a first terminal-attached electric wire and a second terminal holding portion for holding a second terminal-attached electric wire, the first terminal holding portion and the second terminal holding portion are arranged in a first direction, the cover includes an electric wire outlet port through which electric wires, passed through the first terminal holding portion and the second terminal holding portion, extend out in the first direction, the second terminal holding portion is at a position closer to the electric wire outlet port than is the first terminal holding portion, and an end portion, on a side of the cover, of the second terminal holding portion is situated at a position farther from the cover than is an end portion, on the side the cover, of the first terminal holding portion.

### Advantageous Effects of the Invention

According to the invention described in claim 1, the end portion, on the cover side, of the second terminal holding portion is at a position farther from the cover than the end portion, on the cover side, of the first terminal holding portion. Accordingly, at the position close to the electric wire outlet port, the space increases in the direction away from the cover, due to the amount by which the end portion, on the cover side, of the second terminal holding portion is farther from the cover than is the end portion, on the cover side, of the first terminal holding portion. Accordingly, the electric wires are less likely to interfere with each other, so that the electric wires can be passed through the electric wire outlet port with good workability. As a result, the workability in routing electric wires can be improved.

Accordingly, a connector that improves the workability in routing electric wires can be provided.

### BRIEF DESCRIPTION OF THE DRAWINGS

FIG. 1 is an exploded perspective view illustrating a connector according to an embodiment of the present invention.

FIG. 2 is a front view illustrating an outer frame constituting the connector.

FIG. 3 is a longitudinal cross-sectional view of the connector, illustrating a cover attached to the outer frame such that the electric wire outlet port of the cover faces one side (downward).

FIG. 4 is a longitudinal cross-sectional view of the connector, illustrating a cover attached to the outer frame such that the electric wire outlet port of the cover faces another side (upward).

FIG. 5 is a longitudinal cross-sectional view illustrating a modified example of the connector.

### DETAILED DESCRIPTION OF THE EXEMPLARY EMBODIMENT

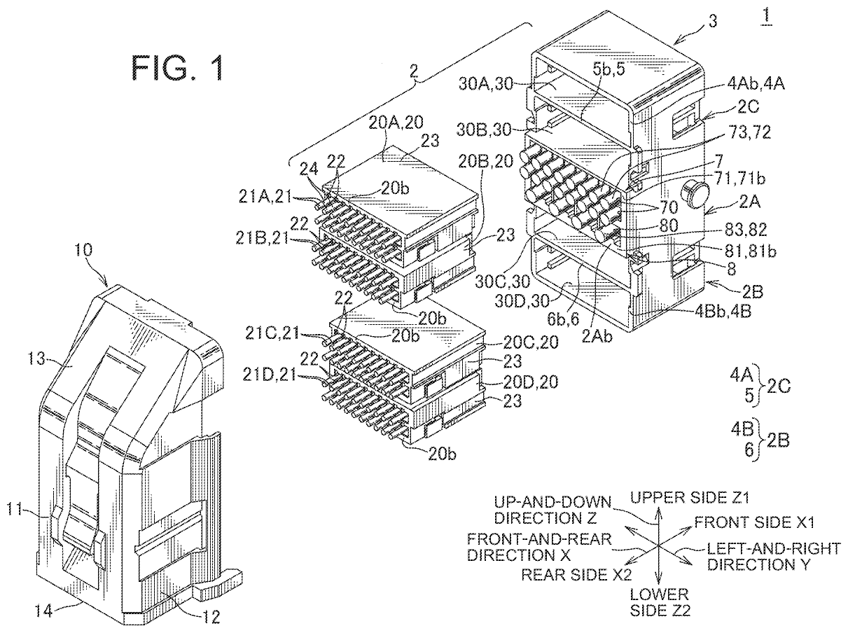

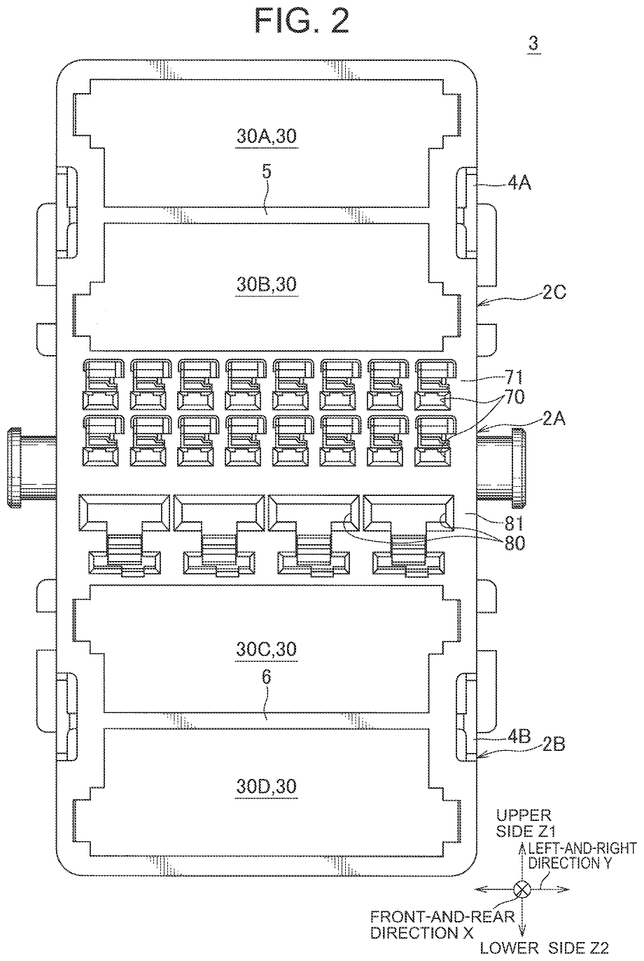

An embodiment of the present invention will be described below with reference to FIGS. 1 to 4. FIG. 1 is an exploded perspective view illustrating a connector 1 according to an embodiment of the present invention. FIG. 2 is a front view illustrating an outer frame 3 that constitutes the connector 1.

As illustrated in FIG. 1, a mating connector, not illustrated, mates with the front side of the connector 1. The connector 1 includes an outer housing 2, an electric wire protective cover 10 (cover) that covers the rear surface of the outer housing 2 on the opposite side from the mating connector, and engagement means, not illustrated, that engages the outer housing 2 and the electric wire protective cover 10.

In the present embodiment, an X direction, a Y direction, and a Z direction are directions that are orthogonal to each other. A direction in which the electric wire protective cover 10 is attached to the outer housing 2 may be referred to as a “front side X1,” and a direction opposite thereto may be referred to as a “rear side X2.” The Y direction may be referred to as a “left-and-right direction”, the Z direction may be referred to as an “up-and-down direction”, one side in the up-and-down direction may be referred to as an “upper side”, and the other side in the up-and-down direction may be referred to as a “lower side”.

As illustrated in FIG. 1, the outer housing 2 includes four (multiple) sub-connectors 20 and an outer frame 3. In the outer frame 3, sub-connector accommodation holes 30 are arranged in the up-and-down direction Z (first direction). In the sub-connector accommodation holes 30, four sub-connectors 20 are accommodated.

As illustrated in FIG. 1, each of the sub-connectors 20 includes 20 (multiple) female-type sub-terminal-attached electric wires 21 and a sub-connector housing 23. The sub-connector housing 23 includes sub-terminal accommodation chambers 22 in which respective sub-terminal-attached electric wires 21 are accommodated. The sub-connectors 20 are configured to be accommodated in the sub-connector accommodation holes 30 of the outer frame 3, explained later.

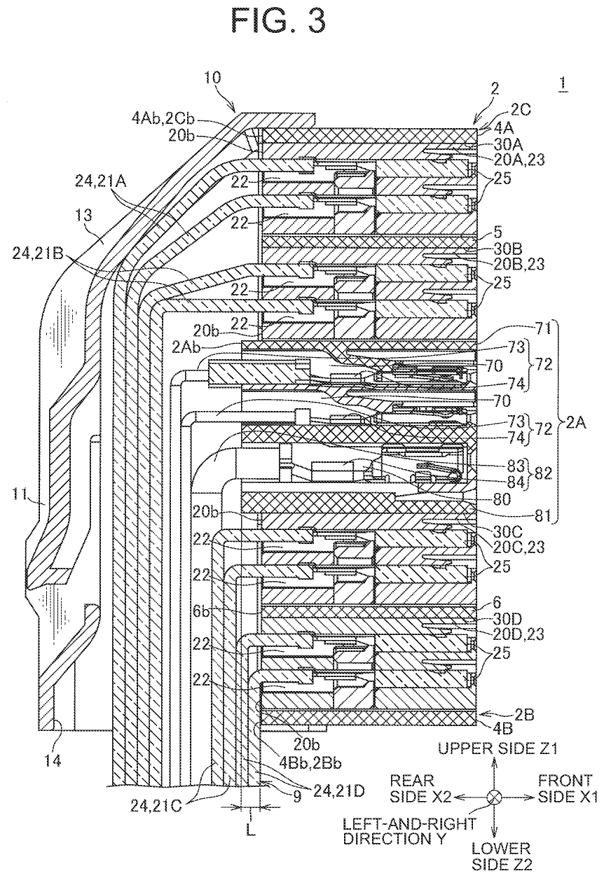

As illustrated in FIG. 3, the sub-terminal-attached electric wire 21 includes a sub-electric wire 24 and a female-type sub-terminal 25. The female-type sub-terminal 25 is connected to a first end portion of the sub-electric wire 24. With each of the sub-connectors 20 being accommodated in the sub-connector accommodation hole 30, the sub-terminal 25 is accommodated in the sub-terminal accommodation chamber 22, and the sub-electric wire 24 connected to the sub-terminal 25 extends from the sub-terminal accommodation chamber 22 toward the rear side X2.

The sub-connector housing 23 is formed into a rectangular parallelepiped shape. The sub-connector housing 23 includes a sub-terminal accommodation chamber 22 penetrating in the front-and-rear direction X. The sub-terminal accommodation chambers 22 arranged in two rows, i.e., upper and lower rows, and in each row, there are 10 sub-terminal accommodation chambers 22 arranged in the left-and-right direction. The sub-connector housing 23 is configured to be insertable in the sub-connector accommodation hole 30 of the outer frame 3 and to be attached to and detached from the sub-connector accommodation hole 30 of the outer frame 3.

Hereinafter, as illustrated in FIG. 1, the four sub-connectors 20 may be referred to as, from top to bottom, a first sub-connector 20A, a second sub-connector 20B, a third sub-connector 20C, and a fourth sub-connector 20D.

As illustrated in FIG. 1, a first end portion of the sub-terminal-attached electric wire 21A, 21 (third terminal-attached electric wire) is held in the first sub-connector 20A, and a second end portion thereof extends through the first sub-connector accommodation hole 30A, 30. Likewise, a first end portion of the sub-terminal-attached electric wire 21B, 21 (third terminal-attached electric wire) is held in the second sub-connector 20B, and a second end portion thereof extends through the second sub-connector accommodation hole 30B, 30.

Furthermore, a first end portion of the sub-terminal-attached electric wire 21C, 21 (second terminal-attached electric wire) is held in the third sub-connector 20C, and a second end portion thereof extends through the third sub-connector accommodation hole 30C, 30. Likewise, a first end portion of the sub-terminal-attached electric wire 21D, 21 (second terminal-attached electric wire) is held in the fourth sub-connector 20D, and a second end portion thereof extends through the fourth sub-connector accommodation hole 30D, 30.

As illustrated in FIGS. 1, 2, the outer frame 3 is integrally provided with an embedded portion 2A (first terminal holding portion), a C-shaped upper frame 4A on the upper side Z1 of the embedded portion 2A, a C-shaped lower frame 4B on the lower side Z2 of the embedded portion 2A, an upper separation wall 5 separating the internal space of the upper frame 4A into the upper and lower spaces, and a lower separation wall 6 separating the internal space of the lower frame 4B into the upper and lower spaces. Specifically, the embedded portion 2A, the upper frame 4A, the lower frame 4B, the upper separation wall 5, and the lower separation wall 6 are structured integrally.

A portion of the outer frame 3 on the lower side Z2 with respect to the embedded portion 2A (first terminal holding portion) may be referred to as a “second terminal holding portion 2B”, and a portion of the outer frame 3 on the upper side Z1 with respect to the embedded portion 2A may be referred to as a “third terminal holding portion 2C”. The second terminal holding portion 2B is a portion on the lower side Z2 with respect to the embedded portion 2A and includes the lower frame 4B and the lower separation wall 6. The third terminal holding portion 2C is a portion on the upper side Z1 with respect to the embedded portion 2A and includes the upper frame 4A and the upper separation wall 5.

The outer frame 3 includes the first sub-connector accommodation hole 30A provided on the upper side Z1 with respect to the upper separation wall 5, the second sub-connector accommodation hole 30B provided on the lower side Z2 with respect to the upper separation wall 5, the third sub-connector accommodation hole 30C provided on the upper side Z1 with respect to the lower separation wall 6, and the fourth sub-connector accommodation hole 30D provided on the lower side Z2 with respect to the lower separation wall 6. The first sub-connector 20A is inserted into the first sub-connector accommodation hole 30A, the second sub-connector 20B is inserted into the second sub-connector accommodation hole 30B, the third sub-connector 20C is inserted into the third sub-connector accommodation hole 30C, and the fourth sub-connector 20D is inserted into the fourth sub-connector accommodation hole 30D.

As illustrated in FIG. 1, in the outer frame 3, rear end portions 4Ab, 4Bb of the upper frame 4A and the lower frame 4B, respectively, and rear end portions 5b, 6b of the upper separation wall 5 and the lower separation wall 6, respectively, are at the same position in the front-and-rear direction X. In other words, a rear end portion 2Bb of the second terminal holding portion 2B and a rear end portion 2Cb of the third terminal holding portion 2C are at the same position in the front-and-rear direction X. The rear end portion 2Bb of the second terminal holding portion 2B and the rear end portion 2Cb of the third terminal holding portion 2C are situated on the front side X1 (on a side away from the cover) with respect to a rear end portion 2Ab of the embedded portion 2A explained later.

When each of the sub-connectors 20 are accommodated in the sub-connector accommodation hole 30 of the outer frame 3, a front end of the sub-connector 20 is brought closer to the rear end of the sub-connector accommodation hole 30, and the sub-connector 20 is inserted into the sub-connector accommodation hole 30. As the insertion progresses, the sub-connector 20 reaches a predetermined position of the sub-connector accommodation hole 30, and as a result, the sub-connector 20 is accommodated in the corresponding sub-connector accommodation hole 30. With each of the sub-connectors 20 being accommodated in the sub-connector accommodation hole 30, a rear end portion 20b of the sub-connector 20 is situated at the same position, in the front-and-rear direction X, as the rear end portions 2Bb, 2Cb of the terminal holding portions 2B, 2C, respectively, as illustrated in FIG. 3.

As illustrated in FIG. 2, the embedded portion 2A includes an upper embedded portion 71 including an upper terminal accommodation chamber 70 (first accommodation chamber), an upper terminal-attached electric wire 72 (first terminal-attached electric wire) accommodated in the upper terminal accommodation chamber 70, a lower embedded portion 81 including a lower terminal accommodation chamber 80 (first accommodation chamber), and a lower terminal-attached electric wire 82 (first terminal-attached electric wire) accommodated in the lower terminal accommodation chamber 80. In FIG. 2, the upper terminal-attached electric wire 72 and the lower terminal-attached electric wire 82 are not illustrated.

As illustrated in FIG. 3, a rear end portion 71b of the upper embedded portion 71 and a rear end portion 81b of the lower embedded portion 81 (hereinafter referred to as the rear end portion 2Ab of the embedded portion 2A) are situated on the same plane that includes the up-and-down direction Z and the left-and-right direction. In other words, in the embedded portion 2A, the rear end portion 71b of the upper embedded portion 71 and the rear end portion 81b of the lower embedded portion 81 are situated at the same position in the front-and-rear direction X.

The upper embedded portion 71 is formed with 16 upper terminal accommodation chambers 70, and upper terminal-attached electric wires 72 are accommodated in the 16 respective upper terminal accommodation chambers 70. The 16 upper terminal accommodation chambers 70 are arranged in two rows, i.e., upper and lower rows, and in each row, there are eight upper terminal accommodation chambers 70 arranged in the left-and-right direction.

The upper terminal-attached electric wires 72 include first thick electric wires 73 (first electric wires) and female-type upper terminal fittings 74 (first terminals) connected to end portions of the first thick electric wires 73. The first thick electric wire 73 is a thick electric wire thicker than the sub-electric wire 24 of each sub-connector 20. An upper terminal fitting 74 of the upper terminal-attached electric wire 72 is accommodated in the upper terminal accommodation chamber 70, and the first thick electric wire 73 connected to the upper terminal fitting 74 extends from the upper terminal accommodation chamber 70 toward the rear side X2.

As illustrated in FIG. 2, the lower embedded portion 81 is provided continuously to the lower side of the upper embedded portion 71. In the lower embedded portion 81, four lower terminal accommodation chambers 80 are formed, and lower terminal-attached electric wires 82 are accommodated in the four respective lower terminal accommodation chambers 80. The four lower terminal accommodation chambers 80 are arranged side by side in the left-and-right direction.

The lower terminal-attached electric wire 82 includes a second thick electric wire 83 (first electric wire) and a female-type lower terminal fitting 84 (first terminal) connected to the end portion of the second thick electric wire 83. The lower terminal-attached electric wire 82 is such that, with the lower terminal fitting 84 being accommodated in the lower terminal accommodation chamber 80, the second thick electric wire 83 extends from the lower terminal accommodation chamber 80 toward the rear side X2. The second thick electric wire 83 is an electric wire thicker than the first thick electric wire 73. The lower terminal-attached electric wire 82 is such that the lower terminal fitting 84 is accommodated in the lower terminal accommodation chamber 80, and the second thick electric wire 83 connected to the lower terminal fitting 84 extends from the lower terminal accommodation chamber 80 toward the rear side X2.

As illustrated in FIG. 1, the electric wire protective cover 10 includes a first wall portion 11 in a rectangular shape extending in a planar direction including the up-and-down direction Z and the left-and-right direction, second wall portions 12, 12, constituting a pair, perpendicularly extending from both edges, in the left-and-right direction, of the first wall portion 11 and facing each other, a third wall portion 13 provided continuously to the edge of the first wall portion 11 on the upper side Z1 and extending in a diagonally upper side Z1, and an electric wire outlet port 14 formed to be surrounded by the first wall portion 11 and the second wall portion 12, 12 constituting the pair and to be open in the up-and-down direction Z. In the present embodiment, the electric wire outlet port 14 is provided on the lower side Z2 with respect to the third wall portion 13, and the electric wire outlet port 14 allows the electric wires 24, 74, 84, passed through the embedded portion 2A and the terminal holding portions 2B, 2C, to extend to the lower side Z2.

The engagement means includes a frame-side engagement portion provided on the outer frame 3 and a cover-side engagement portion provided on the electric wire protective cover 10 and capable of engaging with and disengaging from the frame-side engagement portion. The cover-side engagement portion and the frame-side engagement portion are configured to be symmetrical about a horizontal line. With the engagement means, the electric wire protective cover 10 can be engaged with the outer frame 3 upon being flipped upside down.

Next, a procedure for assembling the connector 1 is explained with reference to FIG. 1.

First, when the upper embedded portion 71 of the outer housing 2 is assembled, the upper terminal fitting 74 is connected to a first end portion of the first thick electric wire 73 to form the upper terminal-attached electric wire 72. Subsequently, the upper terminal fitting 74 of the upper terminal-attached electric wire 72 is accommodated in the upper terminal accommodation chamber 70. Then, the other side of the first thick electric wire 73 is passed through the upper terminal accommodation chamber 70. Accordingly, a first end portion of the first thick electric wire 73 is held in the upper embedded portion 71. By repeating this task, the upper embedded portion 71 is assembled as illustrated in FIG. 1.

When the lower embedded portion 81 is assembled, the lower terminal fitting 84 is connected to a first end portion of the second thick electric wire 83 to form the lower terminal-attached electric wire 82. Subsequently, the lower terminal fitting 84 of the lower terminal-attached electric wire 82 is accommodated in the lower terminal accommodation chamber 80. Then, the other side of the second thick electric wire 83 is passed through the lower terminal accommodation chamber 80. Accordingly, a first end portion of the second thick electric wire 83 is held in the lower embedded portion 81. By repeating this task, the lower embedded portion 81 is assembled as illustrated in FIG. 1.

When each sub-connector 20 is assembled, the sub-terminal 25 is connected to a first end portion of the sub-electric wire 24 to form the sub-terminal-attached electric wire 21. Subsequently, the sub-terminal 25 of the sub-terminal-attached electric wire 21 is accommodated in the sub-terminal accommodation chamber 22. Then, the other side of the sub-electric wire 24 is passed through the sub-terminal accommodation chamber 22. By repeating this task, each of the four sub-connectors 20 is assembled as illustrated in FIG. 1.

Thereafter, as illustrated in FIG. 1, the front end of the first sub-connector 20A is brought closer to the rear end of the first sub-connector accommodation hole 30A to insert the first sub-connector 20A toward the front side X1. As the insertion progresses, the first sub-connector 20A is situated at a predetermined position of the first sub-connector accommodation hole 30A. Accordingly, the first sub-connector 20A is accommodated in the first sub-connector accommodation hole 30A. Furthermore, with the first sub-connector 20A being accommodated in the sub-connector accommodation hole 30, the rear end portion 20b of the first sub-connector 20A and the rear end portion 2Cb of the third terminal holding portion 2C are situated at the same position in the front-and-rear direction X.

By repeating this task, the second sub-connector 20B is accommodated in the second sub-connector accommodation hole 30B, the third sub-connector 20C is accommodated in the third sub-connector accommodation hole 30C, and the fourth sub-connector 20D is accommodated in the fourth sub-connector accommodation hole 30D. With each of the four sub-connectors 20 being accommodated in the corresponding sub-connector accommodation hole 30, the rear end portion 20b of each sub-connector 20, the rear end portion 2Bb of the second terminal holding portion 2B, and the rear end portion 2Cb of the third terminal holding portion 2C are situated at the same position in the front-and-rear direction X.

In this state, the first end portions of the sub-electric wires 24 extending from the third sub-connector 20C and the fourth sub-connector 20D are held in the second terminal holding portion 2B, and the first end portions of the sub-electric wires 24 extending from the first sub-connector 20A and the second sub-connector 20B are held in the third terminal holding portion 2C.

Subsequently, the second end portions of the first thick electric wires 73 extending from the upper embedded portion 71, the second thick electric wires 83 extending from the lower embedded portion 81, and the sub-electric wires 24 extending from the four sub-connectors 20 are bent toward the lower side Z2 and bundled into an electric wire bundle 9. As illustrated in FIG. 3, with the electric wire bundle 9 being bent, the electric wire bundle 9 is such that, at a position close to the electric wire outlet port 14, the sub-electric wires 24 extending from the third terminal holding portion 2C, the thick electric wires 73, 83 extending from the embedded portion 2A, and the sub-electric wires 24 extending from the second terminal holding portion 2B are arranged in this order from the rear side to the front side.

Thereafter, the electric wire protective cover 10 is brought closer to the outer frame 3 such that the electric wire bundle 9 is situated inside the electric wire outlet port 14 of the electric wire protective cover 10, and the outer frame 3 and the electric wire protective cover 10 are engaged with each other by the engagement means. Accordingly, the second end portion of the electric wire bundle 9 extends from the electric wire outlet port 14 of the electric wire protective cover 10.

At this occasion, the rear end portion 2Bb (end portion on the cover side) of the second terminal holding portion 2B is situated on the front side X1 with respect to the rear end portion 2Ab of the embedded portion 2A (end portion, on the cover side, of the first terminal holding portion) (i.e., is situated at a position farther from the cover). Accordingly, as illustrated in FIG. 3, the space at the position close to the electric wire outlet port 14 increases in the front-and-rear direction X (a direction away from the cover) due to an amount (length L) by which the rear end portion 2Bb of the second terminal holding portion 2B is situated on the front side X1 with respect to the rear end portion 2Ab of the embedded portion 2A. Accordingly, the electric wires constituting the electric wire bundle 9 are less likely to interfere with each other, so that the electric wire bundle 9 can be passed through the electric wire outlet port 14 with good workability. In this way, the electric wire protective cover 10 is attached to the outer frame 3. As a result, the connector 1 is completed.

According to the above-described embodiment, the rear end portion 2Bb (end portion on the cover side) of the second terminal holding portion 2B is situated on the front side X1 with respect to the rear end portion 2Ab of the embedded portion 2A (end portion, on the cover side, of the first terminal holding portion) (i.e., is situated at a position farther from the cover). Accordingly, the space at the position close to the electric wire outlet port 14 increases in the front-and-rear direction X (a direction away from the cover) due to the length L by which the rear end portion 2Bb of the second terminal holding portion 2B is situated on the front side X1 with respect to the rear end portion 2Ab of the embedded portion 2A. Accordingly, the electric wires constituting the electric wire bundle 9 are less likely to interfere with each other, so that the electric wire bundle 9 can be passed through the electric wire outlet port 14 with good workability. As a result, the workability in routing electric wires can be improved.

Furthermore, the outer housing 2 includes the third terminal holding portion 2C for holding the sub-terminal-attached electric wires 21A, 21B (third terminal-attached electric wires), wherein in the up-and-down direction Z (first direction), the third terminal holding portion 2C is situated at a position on an opposite side of the embedded portion 2A (first terminal holding portion) from the second terminal holding portion 2B, and the rear end portion 2Cb of the third terminal holding portion 2C (end portion on the cover side) is situated on the front side X1 with respect to the rear end portion 2Ab of the embedded portion 2A. Accordingly, this connector can be used by flipping only the electric wire protective cover 10 upside down, without changing the direction of the outer frame 3 and each sub-connector 20, and furthermore, regardless of the extension direction of the electric wire bundle 9 in the up-and-down direction Z, the space at the position close to the electric wire outlet port 14 increases in the front-and-rear direction X (a direction away from the cover).

Furthermore, the embedded portion 2A (first terminal holding portion) includes the terminal accommodation chambers 70, 80 (first accommodation chambers) in which the terminal-attached electric wires 72, 82 (first terminal-attached electric wires) are accommodated, and the terminal accommodation chambers 70, 80 are embedded cavities integrally formed with the outer housing 2. Accordingly, because the embedded portion 2A is immovable, the space at the position close to the electric wire outlet port 14 increases in the front-and-rear direction X (a direction away from the cover).

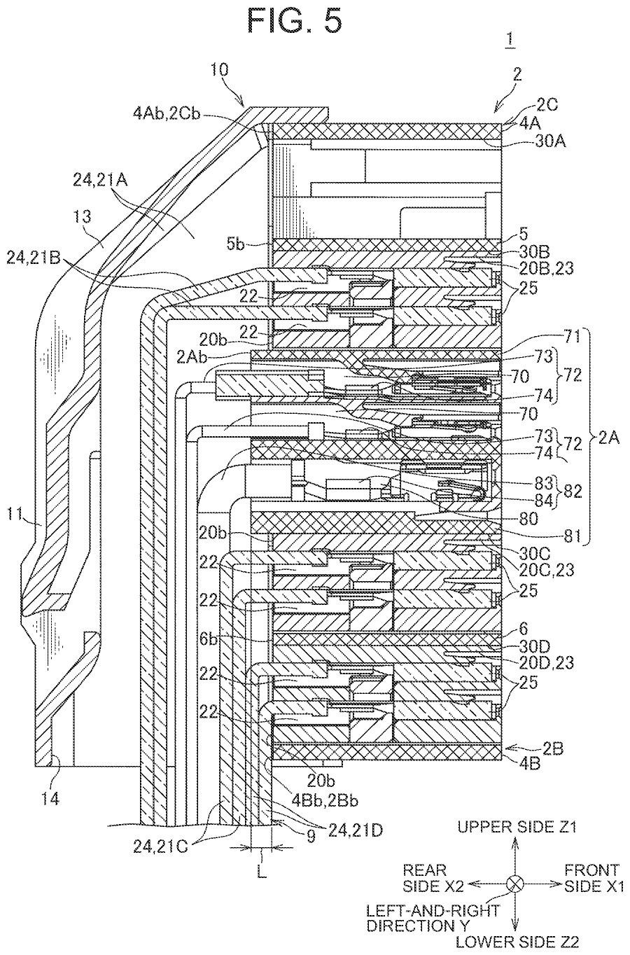

Furthermore, the sub-connector housings 23 in which the sub-terminal-attached electric wires 21A, 21B (third terminal-attached electric wires) are accommodated are provided, and the sub-terminal-attached electric wires 21A, 21B are held in the third terminal holding portion 2C via the sub-connector housing 23. Accordingly, as illustrated in FIG. 5, sub-connector accommodation holes 30A, 30B may be made vacant space by design (only the first sub-connector accommodation hole 30A is made a vacant space in FIG. 5). As a result, the sub-electric wires 24 are not accommodated in a narrow space between the electric wire protective cover 10 and the outer frame 3, which makes it less likely to forcibly bend electric wires, and the workability in routing electric wires can be further improved.

Furthermore, the terminal-attached electric wires 72, 82 (first terminal-attached electric wires) include the terminal fittings 74, 84 (first terminals) and the thick electric wires 73, 83 (first electric wires) connected to the terminal fittings 74, 84, wherein the thick electric wires 73, 83 are thick electric wires thicker than the sub-electric wires 24 (another electric wire). Accordingly, with the electric wire bundle 9 being bent, the electric wire bundle 9 is such that, at a position close to the electric wire outlet port 14, the sub-electric wires 24 extending from the third terminal holding portion 2C, the thick electric wires 73, 83 extending from the embedded portion 2A, and the sub-electric wires 24 extending from the second terminal holding portion 2B are arranged in this order in a direction toward the outer housing 2. This makes it less likely to forcibly bend the thick electric wires 73, 83, and the workability in routing electric wires can be further improved.

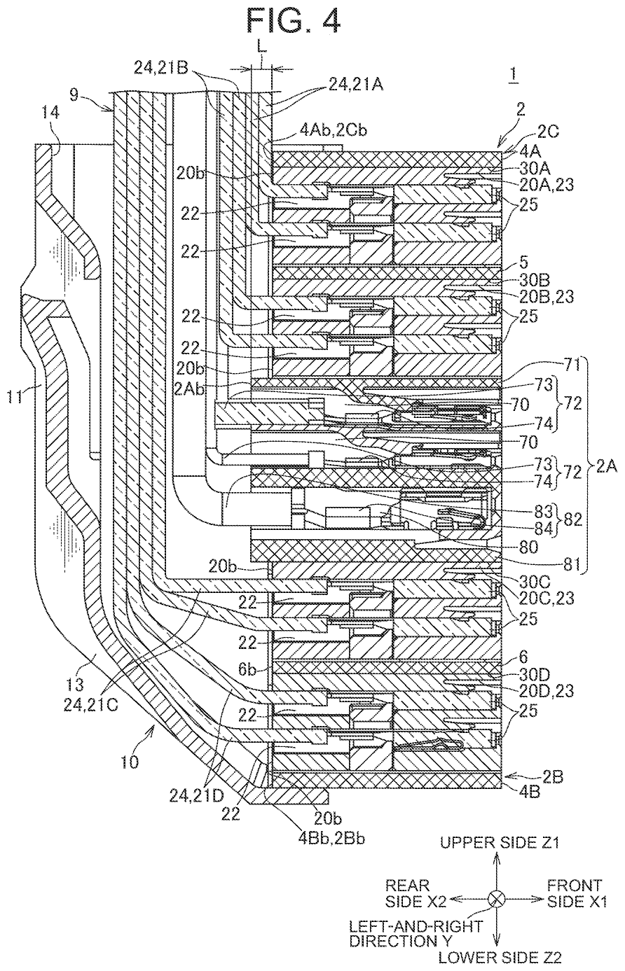

Furthermore, the electric wire protective cover 10 (cover) is configured to be attachable to the outer frame 3, such that the electric wire outlet port 14 faces either the lower side Z2 (one side) or the upper side Z1 (the other side) in the up-and-down direction Z (first direction). Specifically, the electric wire protective cover 10 (cover) can be attached to the outer frame 3 such that, as illustrated in FIG. 3, the electric wire outlet port 14 faces the lower side Z2 (the other side) in the up-and-down direction Z, and also, the electric wire protective cover 10 (cover) can be attached to the outer frame 3 such that, as illustrated in FIG. 4, the electric wire outlet port 14 faces the upper side Z1 (the other side) in the up-and-down direction Z. Accordingly, by flipping upside down the direction of the electric wire protective cover 10 with respect to the outer frame 3, the routing direction of the electric wire bundle 9 can be changed without changing the direction of the outer frame 3. As a result, convenience of the connector 1 can be improved.

The present invention is not limited to the above-described embodiments, and includes other configurations that can achieve the object of the present invention, and the present invention also includes the following modifications and the like.

In the above embodiment, the embedded portion 2A is structured integrally with the outer frame 3, but the present invention is not limited thereto. The upper terminal-attached electric wires 72 held in the upper embedded portion 71 of the embedded portion 2A may be accommodated in a connector housing (not illustrated), and the upper terminal-attached electric wires 72 may be held on the outer frame 3 via the connector housing. Furthermore, the lower terminal-attached electric wires 82 held in the lower embedded portion 81 of the embedded portion 2A may be accommodated in a connector housing (not illustrated), and the lower terminal-attached electric wires 82 may be held on the outer frame 3 via the connector housing. In this case, although stability is somewhat inferior to the present embodiment, substantially the same effects as the present embodiment can be achieved.

In addition, the best configuration, method, and the like for carrying out the present invention have been disclosed in the above description, but the present invention is not limited thereto. Specifically, although the present invention has been particularly illustrated and described primarily with respect to the specific embodiment, a person skilled in the art can make various modifications to the embodiment described above in terms of shape, material, quantity, and other detailed configurations, without departing from the scope of the technical idea and purpose of the present invention. Therefore, the descriptions that limit the shape, material, or the like disclosed above are provided as examples to facilitate understanding of the present invention, and are not intended to limit the present invention, and accordingly, recitations with names of members that do not include some or all of the limitations of the shape, material, or the like are included in the present invention.

### LIST OF REFERENCE SIGNS

1 connector
2 outer housing
2A embedded portion (first terminal holding portion)
2Ab rear end portion of embedded portion (end portion, on the cover side, of the first terminal holding portion)
2B second terminal holding portion
2Bb rear end portion of second terminal holding portion (end portion, on the cover side, of the second terminal holding portion)
2C third terminal holding portion
2Cb rear end portion of third terminal holding portion (end portion of the third terminal holding portion on the cover side)
21A, 21 sub-terminal-attached electric wire (third terminal-attached electric wire)
21B, 21 sub-terminal-attached electric wire (third terminal-attached electric wire)
21C, 21 sub-terminal-attached electric wire (second terminal-attached electric wire)
21D, 21 sub-terminal-attached electric wire (second terminal-attached electric wire)
23 sub-connector housing
24 sub-electric wire (another electric wire)
10 electric wire protective cover (cover)
14 electric wire outlet port
70 upper terminal accommodation chamber (first accommodation chamber)
80 lower terminal accommodation chamber (first accommodation chamber)
72 upper terminal-attached electric wire (first terminal-attached electric wire)
82 lower terminal-attached electric wire (first terminal-attached electric wire)
73 first thick electric wire (first electric wire)
83 second thick electric wire (first electric wire)
74 upper terminal fitting (first terminal)
84 lower terminal fitting (first terminal)
Z up-and-down direction (first direction)

What is claimed is:

1. A connector to be mated with a mating connector, comprising:
an outer housing; and
a cover configured to cover a surface of the outer housing on an opposite side from the mating connector,
wherein the outer housing includes a first terminal holding portion for holding a first terminal-attached electric wire and a second terminal holding portion for holding a second terminal-attached electric wire,
the first terminal holding portion and the second terminal holding portion are arranged in a first direction,
the cover includes an electric wire outlet port through which electric wires passed through the first terminal holding portion and the second terminal holding portion extend out in the first direction,
the second terminal holding portion is at a position closer to the electric wire outlet port than is the first terminal holding portion, and
an end portion, on a side of the cover, of the second terminal holding portion is situated at a position farther from the cover than is an end portion, on the side the cover, of the first terminal holding portion.

2. The connector according to claim 1, wherein
the outer housing includes a third terminal holding portion for holding a third terminal-attached electric wire,
the third terminal holding portion is at a position on an opposite side of the first terminal holding portion from the second terminal holding portion in the first direction, and
an end portion, on the side of the cover, of the third terminal holding portion is situated at a position farther from the cover than is the end portion, on the side the cover, of the first terminal holding portion.

3. The connector according to claim 1, wherein the first terminal holding portion includes a first accommodation chamber in which the first terminal-attached electric wire is accommodated, and
the first accommodation chamber is an embedded cavity integrally formed with the outer housing.

4. The connector according to claim 2, further comprising a sub-connector housing in which the third terminal-attached electric wire is accommodated, and
the third terminal-attached electric wire is held in the third terminal holding portion via the sub-connector housing.

5. The connector according to claim 1, wherein the first terminal-attached electric wire includes a first terminal and a first electric wire connected to the first terminal, and
the first electric wire is a thick electric wire that is thicker than another electric wire.

6. The connector according to claim 1, wherein the cover is configured to be attachable to the outer housing such that the electric wire outlet port faces one side or another side in the first direction.

7. The connector according to claim 2, wherein the first terminal holding portion includes a first accommodation chamber in which the first terminal-attached electric wire is accommodated, and
the first accommodation chamber is an embedded cavity integrally formed with the outer housing.
